(19) United States
(12) Patent Application Publication
(10) Pub. No.: US 2023/0142829 A1
(43) Pub. Date: May 11, 2023

(54) AUTONOMOUS ROOM BOUNDARY DETECTION AND CLASSIFICATION WITH LOW RESOLUTION SENSORS

(71) Applicant: JDRF Electromag Engineering Inc., Mississauga (CA)

(72) Inventors: Roumanos Dableh, Toronto (CA); Ghassan Knayzeh, Burlington (CA); Elias Boukhers, Hamilton (CA)

(73) Assignee: JDRF Electromag Engineering Inc., Mississauga, ON (CA)

(21) Appl. No.: 17/906,875

(22) PCT Filed: Apr. 23, 2020
(86) PCT No.: PCT/IB2020/053862

§ 371 Date: Sep. 21, 2022

(51) Int. Cl. G01S 17/89; G01S 17/46; G01S 7/48

(52) U.S. Cl. CPC G01S 17/89; G01S 17/46; G01S 7/4802

(57) ABSTRACT

An example of an apparatus is provided. The apparatus includes a light source to emit light. The apparatus further includes a light source controller to control the light source. The light source controller is to change an intensity of the light emitted by the light source. In addition, the apparatus includes a low resolution sensor to measure light data from a reflection of the light off a wall. Also, the apparatus includes a memory storage unit to store the light data and corresponding control data. The apparatus includes an image processing engine to locate and to classify the wall based on the light data and the control data.

### BACKGROUND

Buildings typically have rooms which may be used for varying purposes. For example, some rooms may be used as a general meeting room where several individuals may congregate to facilitate communication, such as for a meeting. As another example, some rooms may be used as a private office which may be assigned to one individual at a time, where the individual may have privacy to improve concentration. Other types of rooms may include break rooms, lunch rooms, washrooms, libraries, mechanical rooms, etc. Accordingly, rooms may have a variety of sizes and shapes and are typically separated by a boundary, such as a wall or partition. The boundaries generate a floorplan or an internal map of the building. In addition, the boundaries may be changed and rooms may be altered, such as during a renovation.

### BRIEF DESCRIPTION OF THE DRAWINGS

Reference will now be made, by way of example only, to the accompanying drawings in which:

FIG. 1 is a schematic representation of the components of an apparatus to locate and classify a room boundary;

FIG. 2 is a schematic representation of the components of a lighting controller to identify and control a plurality of lighting devices;

FIG. 3 is a schematic representation of a room where a system of a plurality of lighting devices and a lighting controller are deployed;

FIG. 4 is a flowchart of an example of a method of locating and classifying a wall;

FIG. 5 is a schematic representation of a floor plan with deployed lighting devices and lighting controllers;

FIG. 6 is a schematic representation of the components of another apparatus to locate and classify a room boundary; and

FIG. 7 is a schematic representation of the components of another lighting controller to identify and control a plurality of lighting devices.

### DETAILED DESCRIPTION

Smart lighting technology for commercial buildings offers a myriad of energy conservation, facility management and personalization capabilities. For example, smart lighting may allow lights to be grouped in a flexible manner and for the light level of each group to be automatically adjusted based on input from various sources such as motion sensors, daylight sensors, and a variety of user devices. Although automatic adjustment of lighting levels may be suitable for most of the time, lighting levels may be adjusted by users with a controller, such as wall-mounted switch or interface, to personalize light level within a room in some instances. The controller may have one or more buttons, each of which is assigned to a particular group of lights. In other examples, the controller may have a programmable graphical user interface with virtual buttons on a touch screen.

In some examples, a smart lighting system topology may include one or more sensors mounted on each unit and a controller. Each sensor may be assigned to a group, which may be associated to a button or control interface of the controller. The setup of the units and controller is typically done manually by mapping each unit for the controller. Accordingly, the deployment and configuration of a smart lighting system in a commercial building may be an arduous process that presents challenges. For example, a building may contain thousands of sensors and controllers that are to be networked together and configured to operate in a manner based on user preferences and local lighting codes. This process may be highly prescriptive and involve a design phase, a programming and verification phase and a maintenance phase. Each phase may be performed by different parties and involve several iterations that may take months to complete for large installations. The design phase may be to consider constraints such as the maximum communication range between devices and the maximum number of devices per communication channel. The design phase may also produce an illustration of the group configuration on a lighting plan that shows various groupings of units to be controlled by a controller. The programming and verification phase may be performed by trained technical personnel typically at the location of the installation and may involve implementing the group configuration by installing wiring and switches to the communication channel or by manually assigning the units to a common network address. Operating parameters for each unit, wall switch and additional associated control system hardware and software are set during this phase. The building manager is responsible for maintaining the integrity of the control system topology and all settings as units may be added, removed or relocated post deployment.

A system including a network of apparatus and a lighting controller that self-organize into logical group configurations is provided. It is to be appreciates by a person of skill in the art that the apparatus, method, and system describe may reduce or eliminate the design process, the programming and verification process, and/or the maintenance process involved with smart lighting systems. In particular, the system is autonomous such that upon “power-up”, the system may self-organize without any user intervention. In the present example, the system may also be decentralized and autonomous, such that there is no host controller, external software agent or mobile device to start, monitor or end the process. Accordingly, the deployment and configuration process may be based exclusively on contextual awareness between the apparatus and the lighting controller via the detection of room boundaries, the physical arrangement of the apparatus and the lighting controller and sensory data collected, such as motion patterns and daylight distributions. Furthermore, the system may automatically detects and adapts to changes to room boundaries, such as the position of a movable wall, objects being added, removed or relocated, and reconfiguration of room boundaries, such as from a renovation of the space. The apparatus may classify room boundaries as one of opaque walls, interior transparent or translucent walls, exterior windows and doorways.

In some examples, each apparatus and lighting controller may divide themselves into groups. The groups are not particularly limited and may be based on room boundaries that may be dynamically updated when a space is re-configured. Furthermore, since the system may be decentralized in some examples, each device in the system may not be in direct communication with all other devices during operation. Instead, each apparatus or lighting controller may be in communication with proximate apparatus or lighting controllers. Therefore, the system may be scaled to a large number of apparatus and a lighting controllers with reduced latency and increased reliability.

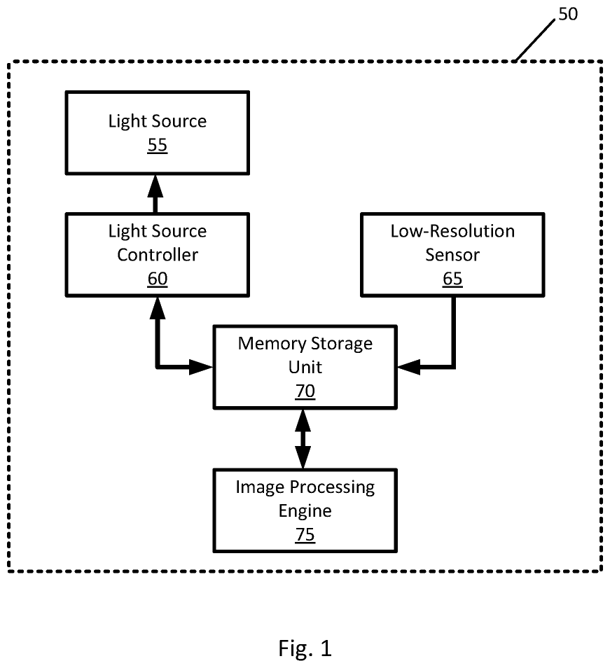

Referring to FIG. 1, a schematic representation of an apparatus to locate and classify a room boundary, such as a wall, is generally shown at 50. The apparatus 50 may include additional components, such as various additional interfaces and/or input/output devices such as indicators to interact with a user of the apparatus 50. The interactions may include viewing the operational status, updating parameters, or resetting the apparatus 50. In the present example, the apparatus 50 is to collect data based on actively generated signals to locate a room boundary and to classify the room boundary. In the present example, the apparatus 50 includes a light source 55, a light source controller 60, a low resolution sensor 65, a memory storage unit 70, and an image processing engine 75.

The light source 55 is to emit light. In the present example, the light source 55 is to emit light that is in the infrared spectrum. The light may be monochromatic, or emit a band of light with a peak wavelength in the infrared spectrum. For example, the light source 55 may emit light having a peak wavelength greater than about 780 nm to be beyond the typical visual range of a human eye. In some examples, the peak wavelength may be about 850 nm. The light source 55 is not particularly limited and may be any device capable of generating light that may be reflected off a surface, such as a room boundary, and detected by the low resolution sensor 65. For example, the light source 55 may be an incandescent light bulb, a fluorescent light bulb, a laser, or a light emitting diode. The area onto which the light source 55 projects is not particularly limited. In the present example, the light source 55 may project a uniform intensity across the field of view of the low resolution sensor 65. In other examples, the light source 55 may direct wider or narrow light, or the illumination may not be uniform across substantially all of the field of view.

In the present example, the light source controller 60 is to control the light source 55. In particular, the light source controller 60 may provide power to the light source 55 or turn off the light source 55 by cutting off power. Furthermore, the light source controller 60 further controls the intensity of the light source 55. For example, the light source controller 60 may vary the intensity of the light source 55 to adjust the illumination level to achieve different effects in the reflected light that may be subsequently processed.

The low resolution sensor 65 is to measure light data from a reflection off a room boundary, such as a wall. In particular, the low resolution sensor 65 may be used to specifically measure the reflected light from the light source 55. In the present example, the low resolution sensor 65 may be a two-dimensional image sensor is capable of capturing images in the infrared or near infrared spectrum. For example, the low resolution sensor 65 may also be capable of capturing images in part of or all of the visible spectrum. In other examples, the low resolution sensor 65 may be used to detect light having a wavelength of about 850 nm with pixels having a high quantum efficiency in the 850 nm spectrum. In other examples, the low resolution sensor 65 may also be capable of capturing images in part of or all of the visible spectrum. In some examples, a lens may be used to provide a wide coverage area to increase a field of view to detect motion patterns and objects. The low resolution sensor 65 has a resolution sufficiently low such that the light data captured is cannot be used to distinguish or identify people. However, the low resolution sensor 65 may be able to detect the presence of walls, windows, and doorways. In addition, movement patterns of objects and people within the field of view may also be measured. The number of pixels in each low resolution sensor 65 is not particularly limited. For example, each low resolution sensor 65 may have about 4 pixels to cover a field of view of about 20 m. In other examples, the low resolution sensor 65 may have more or fewer pixels to improve detection of objects, but not to provide capability to distinguish facial features of a person.

The memory storage unit 70 is to store the light data measured by the low resolution sensor 65. In addition, the memory storage unit 70 is to store the corresponding control data provided by the light source controller 60 as the low resolution sensor 65 measures the light data. For example, the memory storage unit 70 may store the light data and the control data together in a single database as a function of time. Accordingly, as the intensity of the light source 55 is varied by the light source controller 60, the low resolution sensor 65 is used to detect a change in the light data due to the reflected light. In the present example, the memory storage unit 70 may be in communication with the light source controller 60 and the low resolution sensor 65 where they each may include processing capabilities to read and write to the memory storage unit 70 directly. In other examples, a separate processor (not shown) may be used to control the light source controller 60 and the low resolution sensor 65 and act as in intermediary for communications between each of the light source controller 60 and the low resolution sensor 65 and the memory storage unit 70.

The memory storage unit 70 may be also used to store addition data to be used by the apparatus 50. For example, the memory storage unit 70 may store motion data as well as ambient light data as discussed in greater detail below. Furthermore, the memory storage unit 70 may be used to store mapping data as well as information from adjacent or proximate devices.

In the present example, the memory storage unit 70 may include a non-transitory machine-readable storage medium that may be any electronic, magnetic, optical, or other physical storage device. In other examples, the memory storage unit 70 may be an external unit such as an external hard drive, or a cloud service providing content. The memory storage unit 70 may also be used to store instructions for general operation of the apparatus 50. In particular, the memory storage unit 70 may store an operating system that is executable by a processor to provide general functionality to the apparatus 50, for example, functionality to support various applications. The memory storage unit 70 may additionally store instructions to operate the image processing engine 75. Furthermore, the memory storage unit 70 may also store control instructions to operate other components and peripheral devices of the apparatus 50, such additional sensors, cameras, user interfaces, and light sources.

The image processing engine 75 is to locate and classify a room boundary, such as a wall, based on the light data and the control data stored in the memory storage unit 70. In contrast to a high resolution image sensor which may be used to easily locate room boundaries, such as walls, and to classify the wall type into various types such as opaque walls, transparent walls, translucent walls, exterior windows, and doorways with image processing algorithms, the low resolution sensor 65 is not capable of making such determinations based solely on the light data measured by the low resolution sensor 65. In the present example, the light data is combined with the control data which records changes in the illumination level from the light source 55. The image processing engine 75 may use the combined data to locate and classify room boundaries based on the reflections, intensity distributions and other features. In some examples, the intensity distribution may be dependent on the intensity of the light emitted by the light source 55 such that the dependence is uniquely associated with a specific type of wall or room boundary. Therefore, the image processing engine 75 may use machine learning techniques, such as a trained classification model to perform accurate locating of a room boundary as well as classify the room boundary as a type of wall, such as an opaque wall, a transparent wall, a translucent wall, an exterior wall, a windowed wall or a wall with a doorway. It is to be appreciated that these types of walls are not particularly limited and may be defined such that the types of walls are mutually exclusive.

In the present example, the image processing engine 75 may assign a confidence value to the classification. The confidence value may be associated with the accuracy of the classification and may be calculated using metrics such as an F-score.

The manner by which the image processing engine 75 carries out the locating and classification functions is not limited. In the present example, the light data measured by the low resolution sensor 65 may be stored in the memory storage unit as a primary dataset. The primary dataset may be combined with a supplementary data set containing a different type of data than the primary dataset to improve the accuracy of classification when analysed in combination with the primary dataset. The supplementary data type is not limited and may be spatial, temporal or both. In some examples, the supplementary data may include current or historic ambient light readings as a function of time. In other examples, the supplementary data may include current or historic motion patterns, such as a detected motion detected from a specific direction.

The supplementary dataset may be collected by the low resolution sensor 65. In other examples, the supplementary dataset may be collected by other sensors, such as a separate daylight sensor or motion sensor. The supplementary data may be combined with the primary dataset using various fusion techniques that involve various weighting factors to increase the accuracy of the combined dataset.

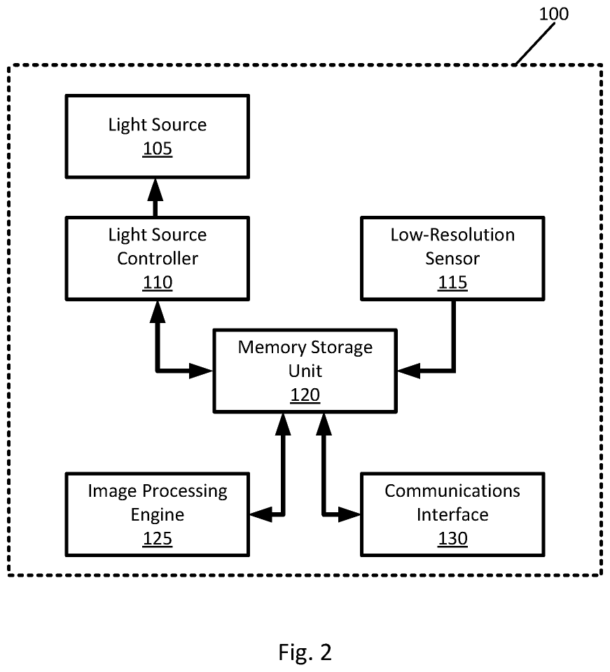

Referring to FIG. 2, a schematic representation of a lighting controller to identify and control a plurality of lighting devices is generally shown at 100. The lighting controller 100 may include additional components, such as various additional interfaces and/or input/output devices such as indicators to interact with a user of the lighting controller 100. The interactions may include viewing the operational status on a touchscreen device (not shown). In the present example, the lighting controller 100 is to collect data based on actively generated signals to locate a room boundary and to group a plurality of lighting devices. In the present example, the lighting controller 100 includes a light source 105, a light source controller 110, a low resolution sensor 115, a memory storage unit 120, an image processing engine 125, and a communications interface 130.

In the present example, the lighting controller 100 may locate and classify a room boundary in a similar manner as the apparatus 50. For example, the lighting controller 100 may use the light source 105, light source controller 110, low resolution sensor 115, memory storage unit 120, and image processing engine 125 in a similar manner to the light source 55, light source controller 60, low resolution sensor 65, memory storage unit 70, and image processing engine 75. In some examples, the light source 105 and low resolution sensor 115 may be capable of locating and classifying walls at a greater range than the corresponding components in the apparatus 50.

The communications interface 130 is to transmit a control signal to a plurality of lighting devices, which may each include an apparatus 50. In the present example, each lighting device of the plurality of lighting devices is to be bounded by a room boundary, such as a wall. The determination of which lighting device is to be included in the plurality of lighting devices is not particularly limited. For example, the memory storage unit 120 may include a mapping of the room boundaries as determined by the image processing engine 125.

In the present example, the communications interface 130 may communicate with lighting devices over a network, which may be a public network shared with a large number of connected devices, such as a WiFi network or cellular network. The connection with external devices may involve sending and receiving electrical signals via a wired connection with other external devices or a central server. Since the lighting controller and lighting devices are typically mounted at a stationary location on a wall, using a wired connection between the lighting controller and the external device may provide a robust connection. In other examples, the communications interface 130 may connect to external devices wirelessly to simply the setup procedure since the process may not involve placing wires in the walls. For example, the communications interface 130 may be a wireless interface to transmit and receive wireless signals directly to each external device via a Bluetooth connection, radio signals or infrared signals and subsequently relayed to additional devices.

In other examples, the mapping of the room boundaries may be received from an external device, such as a lighting device with an apparatus 50 to locate and classify room boundaries via the communications interface 130. The mapping data may also include an identifier to indicate from which lighting device the mapping data is received. Accordingly, the lighting controller 100 may receive data from multiple lighting devices within the room boundary, or wall. In some examples, the lighting controller 100 may receive identifiers to indicate which lighting device with an apparatus 50 has identified itself to be within the same room as the lighting controller 100 such that the lighting devices may be grouped together. In further examples, mapping data received via the communications interface 130 may be compared with internally generated mapping data to validate the mapping data to determine which lighting devices are within a room boundary.

The control signals transmitted from via the communications interface 130 is not particularly limited. For example, the control signals may control all of the lighting devices within a room to adjust light level and to operate under various rules, user inputs, and energy conservation settings. In other examples, the lighting controller 100 may control a subset of the lighting devices within a room such that groups of lights may be controlled in unison. The manner by which the lighting devices are divided into subsets of lighting device is not limited. In some examples, the lighting devices may autonomously divide among themselves and assign generated an identifier to be received by the lighting controller 100. In other examples, the lighting controller 100 may divided the lighting devices based on type, which may be identified with an identifier.

For example, the area spanned by a plurality of the lighting devices controlled by the lighting controller may have an upper limit due to hardware limitations, or by design which may be to meet building codes or satisfy installation specifications. Accordingly, some lighting devices co-located in the same room may be divided into a separate group based on this area limitation. In this example, the division of lighting devices into subsets of a plurality may represent a logical choice of lighting devices based on the mapping data as determined by each apparatus 50 or lighting controller 100. For example, the lighting devices may be divided such that the lighting devices form a regular shaped area or two or more contiguous regular shape areas. In other examples, the total power consumed by the lighting devices within an area may be calculated to determine a lighting power density of the area. The lighting power density may then be used as an additional or alternative metric to limit the number of lighting devices controlled by a lighting controller 100.

Accordingly, the lighting devices co-located in a room and that do not exceed an area limit may be organized into a plurality of lighting devices. The lighting devices that belong to a given group may form a continuous and uniform arrangement to capture the intent of an architectural design. In some examples, the relative distance between lighting devices may be used in whole or in part to determine the groupings. For example, a room with lighting devices that are located at a distance of about one meter or about four meters apart may group lighting devices separated by about one meter into group. In other examples, this grouping may be further subdivided such that lighting devices in a row are grouped together. In further examples, a concentric arrangements of lighting devices may be grouped.

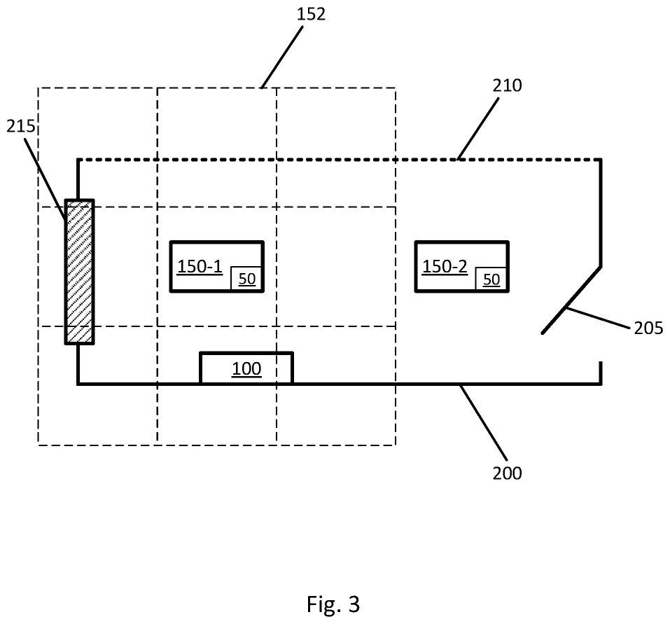

Referring to FIG. 3, a room with a plurality of lighting devices 150-1 and 150-2 (generically, these lighting devices are referred to herein as “lighting device 150” and collectively they are referred to as “lighting devices 150”, this nomenclature is used elsewhere in this description) deployed in operation is shown. In the present example, each of the lighting devices 150 are substantially identical units and operate together with the lighting controller 100 as a system that may be autonomously grouped or associated with each other upon placing each of the lighting devices 150 and the lighting controller 100 without wiring or additional configuration by an installer. In the present example, each of the lighting devices 150 includes an apparatus 50 to locate and classify room boundaries such as the opaque wall 200, doorway wall 205, transparent wall 210 and exterior window wall 215.

In the present example, the lighting devices 150 are to locate the positions at which they are disposed within the room. The manner by which the lighting devices locate their respective positions is not particularly limited. For example, each lighting device 150 may have an apparatus 50 to locate and classify room boundaries. The located and classified room boundaries, such as walls, may then be used to generate a floor plan using a mapping engine. In addition, the lighting devices 150 may be detect stationary objects within the room. It is to be appreciated that the range of the apparatus 50 on each lighting device 150 may not be able to locate and classify all the room boundaries of the room in some examples. For example, the lighting device 150-1 may be able to locate a portion of the opaque wall 200, the exterior window wall 215, and a portion of the transparent wall 210 and the lighting device 150-2 may be able to locate another portion of the opaque wall 200, the doorway wall 205, and another portion of the transparent wall 210.

In some examples, each lighting device may have multiple defined regions of interest within its field of view. For example, the lighting device 150-1 may have nine defined regions of interest arranged in a 3×3 grid 152 as shown in FIG. 3. The number of regions of interest is not limited and may be selected based consideration of factors such as the coverage area, processing power, classification accuracy, and data privacy. In this example, the lighting device 150-1 may assign a classification of the room boundary to each region in the grid 152. The classification assigned to a given region of interest may not match the category assigned to another region of the grid 152. For example, some regions in the grid 152 corresponding to the opaque wall 200 may classify to room boundary as such. Similarly, regions in the grid 152 corresponding to the exterior window wall 215 and a portion of the transparent wall 210 may be classified.

In further examples, it is to be appreciated that the lighting devices 150 may use supplementary data such as directional motion patterns and/or ambient light measurements as a function of time. In particular, the supplementary may be used to locate and/or classify a room boundary, such as the opaque wall 200, doorway wall 205, transparent wall 210, or exterior window wall 215.

Furthermore, the lighting devices 150-1 and 150-2 may communicate the room boundaries and combine data to identify their positions within the room. In other examples, the lighting device 150 may also include a mapping engine to generate a floor plan of the room that may be stored locally on a memory storage unit within each lighting device 150 or shared with other lighting devices 150 for verification or appending to a floor map limited by the range of the sensors in the lighting devices 150. In further examples, the floor plan may be used to group the lighting devices 150 by identifying the lighting devices within the same room. The process by which the lighting devices 150 determine whether other devices are in the same room may communicate partial floor plans to other lighting devices and a voting process may be used. In some examples, the voting process may involve taking a confidence value into consideration to weigh the data from each lighting device 150.

In the present example, the lighting devices 150-1 and 150-2 are autonomously grouped together. The manner by which the lighting devices 150-1 and 150-2 are grouped is not limited. For example, it may be grouped based on the being in the same room as each other. Furthermore, each of the lighting devices 150-1 and 150-2 are in communication with the lighting controller 100 and also grouped the lighting controller 100 autonomously. The lighting controller 100 is to transmit control signals to the lighting devices 150-1 and 150-2.

During the operation of the lighting devices 150, it is to be appreciated by a person of skill with the benefit of this description that the lighting devices 150 may interfere with each other as their respective apparatus 50 emits light to locate and classify a room boundary. In a specific example, the lighting device 150-1 may emit light via the apparatus 50 at any time to generate light data to locate and classify a room boundary. Similarly, the lighting device 150-2 may do the same and detect the light emitted by the lighting device 150-1 which may interfere with the measurement of light data by the lighting device 150-2. To address this interference, the lighting device 150-2 may check whether the lighting device 150-1 is in the process making a measurement prior to beginning the measurement process carried out by the lighting device 150-2 to avoid interference with the lighting device 150-1. In some examples, the lighting devices 150-2 may not be aware of the lighting device 150-1 and may not be able to obtain the status of the lighting device 150-1. In particular, the lighting devices 150 is such systems may not be able to obtain the status of other lighting devices 150. Although the present example illustrates two lighting devices 150, it is to be appreciated that the system may be scaled to many more lighting devices such that it is impractical to implement coordination across all lighting devices in a system due to large propagation delays in a large decentralized system.

Accordingly, each lighting device 150 may coordinate the emission of light from an apparatus 50 locally with the activation sequence of proximate lighting devices 150. For example, an activation sequence may involve one or more successive on/off cycle of an infrared light source. The activation sequence is not limited to a specific number of on/off cycles, the on level, the off level, and the duration of time between levels or successive cycles. The coordination of the activation sequence may involve a pattern that results in one lighting device 150 being in a state of activation sequence at a given time relative to proximate lighting devices.

In some examples, the lighting devices 150 may communicate with each other to determine and/or confirm a room boundary. For example, each lighting device 150 may execute a process involving the measurement of light data in a manner that does not cause interference. The exchange of light data from each lighting device 150 to the other lighting devices 150 that may be detected by a prescribed number of heartbeat messages. Accordingly, each lighting device 150 may then combine lighting data into a database to locate and classify room boundaries as described above.

The manner by which the lighting devices 150 in a large decentralized system may coordinate autonomously is not particularly limited. For example, the lighting devices 150 may not have knowledge of all other lighting devices 150 in the system or even the number of lighting devices in the system. In some examples, this coordination process may involve the construction of a spanning tree with one or more unique initiators and may also involve the use of traversal protocols whereby special messages or tokens are used to visit each lighting device 150 sequentially. Execution of some or all of these processes may assume that each lighting device 150 to be in the same state. It is to be appreciated by those with skill in the art and the benefit of this description that a variety of protocols may be used to implement suitable processes. The unique initiator may be selected and contentions may be resolved among multiple candidate initiators.

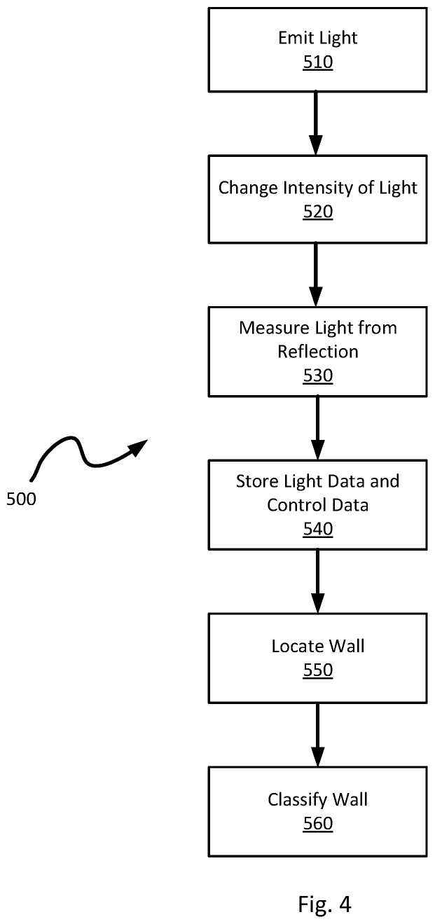

Referring to FIG. 4, a flowchart of an example method of locating and classifying a room boundary is generally shown at 500. In order to assist in the explanation of method 500, it will be assumed that method 500 may be performed with the apparatus 50. Indeed, the method 500 may be one way in which the apparatus 50 may be configured. Furthermore, the following discussion of method 500 may lead to a further understanding of the apparatus 50 and its components. In addition, it is to be emphasized, that method 500 may not be performed in the exact sequence as shown, and various blocks may be performed in parallel rather than in sequence, or in a different sequence altogether.

Beginning at block 510, light is emitted onto to wall. The manner by which the light is emitted is not particularly limited. In the present example, the apparatus 50 may include a light source 55 from which light may be emitted. The light may be monochromatic, or emit a band of light with a peak wavelength in the infrared spectrum. For example, the light source 55 may emit light having a peak wavelength greater than about 780 nm to be beyond the typical visual range of a human eye. In some examples, the peak wavelength may be about 850 nm.

Block 520 comprises changing the intensity of the light emitted at block 510. By changing the intensity of the light emitted, it is to be appreciated that the illumination level of light generated at block 510 may be adjusted. The light generated at block 510 is generally not visible to the human eye so that varying the illumination level does not generate undesired effects and may not be noticeable to occupants in the room. Furthermore, in examples where an apparatus 50 is part of a lighting device 150, the light generated at block 510 is separate from the light generated to illuminate the room in which the lighting device 150 is disposed. In particular, the light intensity may be varied in a manner to adjust the illumination level to achieve different effects in the reflected light that may be subsequently processed to determine a location and classification of the wall. The manner by which the intensity of the light is varied may be recorded in as control data.

Next, block 530 comprises measuring, with a low resolution sensor 65, the light generated at block 510 as it is reflected off the wall. The measured light may then be stored as light data along with the control data generated by the light source controller on a memory storage unit 70 at block 540.

Blocks 550 and 560 use the light data and the control data to locate the position of the wall relative to the apparatus 50 and to classify the wall, respectively. An image processing engine 75 may be used to locate the wall and classify the wall. In the present example, the intensity distribution measured at block 530 may be dependent on the intensity of the light emitted by the light source 55 such that the dependence is uniquely associated with a specific type of wall or room boundary. Therefore, the image processing engine 75 may use machine learning techniques, such as a trained classification model, to perform accurate locating of a room boundary as well as classify the room boundary as a type of wall, such as an opaque wall, a transparent wall, a translucent wall, an exterior wall, a windowed wall or a wall with a doorway. It is to be appreciated that these types of walls are not particularly limited and may be defined such that the types of walls are mutually exclusive.

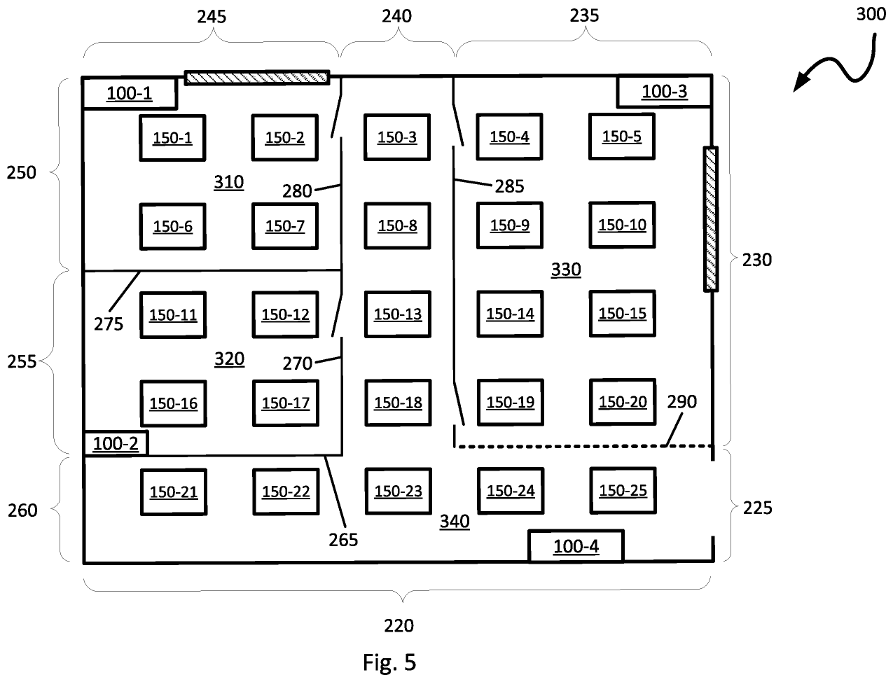

Referring to FIG. 5, a building space 300 with a plurality of rooms 310, 320, 330 and hallway 340 is shown. The building space 300 also includes a plurality of lighting controllers 100-1, 100-2, 100-3, 100-4 (generically, these lighting controllers are referred to herein as “lighting controller 100” and collectively they are referred to as “lighting controllers 100”), a plurality of lighting devices 150-1, 150-2, . . . , 150-25 (generically, these lighting devices are referred to herein as “lighting device 150” and collectively they are referred to as “lighting devices 150”) deployed throughout the building space 300. The building space 300 may be an office unit, a warehouse, a residential home, or any other interior space. It is to be appreciated that in the present example, the lighting devices may be pre-installed in the building space prior to the placement of the walls to form the rooms 310, 320, and 330.

Each of the lighting devices 150 may be substantially identical units and unaware of the manner by which the building space 300 is divided. Similarly, each of the lighting controllers 100 may be substantially identical units and unaware of the manner by which the building space 300 is divided or which of the lighting devices 150 are within the same room. The lighting controllers 100 and the lighting devices 150 may include a light emitter and a low resolution sensor to locate and classify the room boundary. The classification of the room boundary is not limited and may include different wall types, such as an opaque wall 220, 235, 240, 250, 255, 260, 265, 275, a doorway wall 225, 270, 280, 285, an exterior window wall 230, 245, and an interior translucent wall 290.

In the present example, the lighting controllers 100 and the lighting devices 150 may not have prior knowledge of the physical environment, including the building size or type, room size, room layout, room boundary or the physical arrangement within the building or any given room. The lighting controllers 100 and the lighting devices 150 are not provided with any information that describes the physical environment, such as via a connection to a server or to another external device. Without knowledge of the number of devices (the lighting controllers 100 and the lighting devices 150 in aggregate or by type), the devices may not be able to maintain an internal list of all devices connected to the system due to limitations of each device, such as the size of a local memory storage unit. In some examples, the lighting controllers 100 and the lighting devices 150 may keep a list of about 50 other devices that may be added to the system with over 500 devices.

Continuing with the present example, a collection of the lighting controllers 100 and the lighting devices 150 may self-organize, cooperate together and operate in a spontaneous manner to solve the common goal of determining a group having a plurality of lighting devices 150 each that may be controlled by a lighting controller 100 without human involvement or an external software agent to manage, process, compute or instruct the lighting devices 150 at any time.

In some examples, the process of forming the group of devices with a plurality of lighting devices 150 may involve application of a set of rules or conditions. First, the devices to be grouped may be located within the same room. Second, the area spanned by the lighting devices 150 and controlled by the lighting controller 100 may be limited to a predefined amount. Third, the lighting controllers 100 and the lighting devices 150 that belong to a given group may form a continuous and uniform arrangement. In some examples, the groups of lighting devices may be irregularly shaped on a floor plan. Fourth, the lighting controllers 100 and the lighting devices 150 within the same room may be arranged into a logical number of groups. Defining the lighting controller 100 groupings in a given room may depends on the number of lighting devices 150 in the room, the arrangement of the lighting devices 150 in the room as well as other factors.

In some examples, the lighting devices 150 within the same room may self-assign an identifier that is common to the lighting devices 150 within the same room and unique from identifiers used by other the lighting devices 150 in the same system. In other examples, the lighting controllers 100 and the lighting devices 150 may be used to determine an area covered by all lighting controllers 100 and lighting devices 150 in the system and limit the area spanned by a given group or collection of groups such that no group spans an area greater than a prescribed amount. For example, the electrical building code in some jurisdictions limit the maximum area of a group controlled by a single wall controller to be no more than 2,500 sq. ft. if the total building area is less than 10,000 sq. ft.

In some examples, the lighting controller 100 may be used to control more than one group of lighting devices 150. The number of groups of lighting devices 150 that are controlled by a lighting controller 100 may be determined dynamically based on a discovered arrangement of lighting devices 150 within a room.

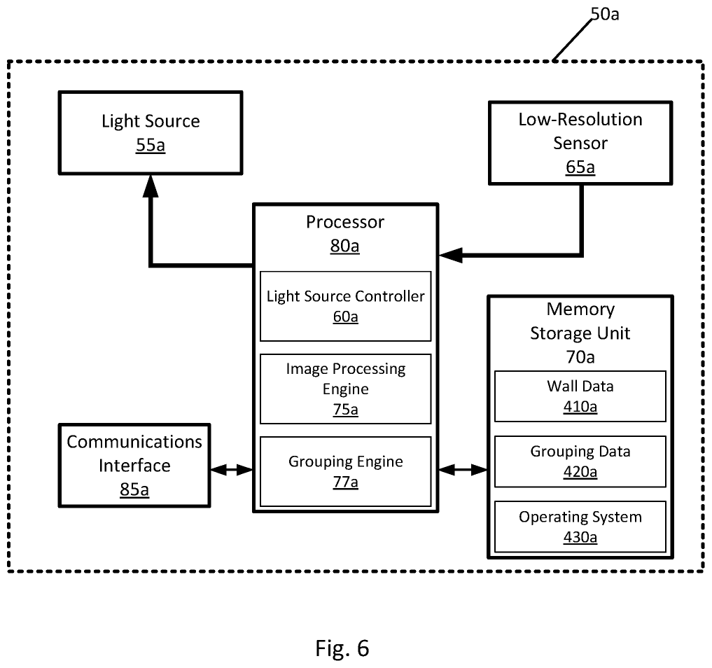

Referring to FIG. 6, another schematic representation of an apparatus to locate and classify a room boundary, such as a wall, is generally shown at 50a. Like components of the apparatus 50a bear like reference to their counterparts in the apparatus 50, except followed by the suffix “a”. In the present example, the apparatus 50a is to collect data based on actively generated signals to locate a room boundary and to classify the room boundary group other apparatus autonomously. Furthermore, the apparatus 50a is to communicate the groupings to external devices. In the present example, the apparatus 50a includes a light source 55a, a low resolution sensor 65a, a memory storage unit 70a, a processor 80a and a communications interface 85a. In the present example, the processor 80a includes components to operate a light source controller 60a, an image processing engine 75a, and a grouping engine 77a.

In the present example, the light source 55a and the low resolution sensor 65a are substantially similar to the light source 55 and the low resolution sensor 65, respectively. In particular, the light source 55a is to emit light that is not visible to the human for use in locating and classifying room boundaries. The low resolution sensor 65a is to measure light data based on the reflected non-visible light as it is varied in intensity. Accordingly, the light source 55a and the low resolution sensor 65a may operate without changing the room lighting levels that may be visible to a human eye.

The processor 80a may include a central processing unit (CPU), a microcontroller, a microprocessor, a processing core, a field-programmable gate array (FPGA), an application-specific integrated circuit (ASIC), or similar. The processor 80a may cooperate with the memory storage unit 70a to execute various instructions stored thereon. For example, the memory storage unit 70a may store an operating system 430a that is executable by the processor 80a to provide general functionality to the apparatus 50a, including functionality to locate and classify a room boundary. Examples of operating systems include Android Things™ Apache Mynewt™ Zephyr™, and Windows 10 IoT™. Further operating systems may also include Windows™, macOS™, iOS™, Android™, Linux™, and Unix™. The processor 80a may also control the light source 55a via a light source controller 60a and process light data measured by the low resolution sensor 65a with an image processing engine 75a. In further examples, the memory storage unit 70a may be used to store additional applications that are executable by the processor 80a to provide specific functionality to the apparatus 50a, such as functionality to control various components such as the low resolution sensor 65a, the communications interface 85a, and the light source 55a at the firmware level.

In the present example, the memory storage unit 70a may also maintain databases to store various data used by the apparatus 50a. For example, the memory storage unit 70a may include wall data 410a and grouping data 420a. The memory storage unit 70a may additionally store instructions to carry out operations at the driver level as well as other hardware drivers to communicate with other components and peripheral devices of the apparatus 50a, such as various user interfaces to receive input or provide output.

In the present example, the database storing wall data 410a may store information about room boundaries within the field of view of the low resolution sensor 65a. In particular, the wall data 410a may include information of the location and type of room boundary. For example, the field of view of the sensor 65a may be divided into a grid. In this example, each region or cell of the grid may be assigned a position and a description of the contents of the grid. For example, the cell may include no room boundary. As another example, the cell may include a room boundary such as a wall. The wall may be further classified into a type of wall, such as an opaque wall, a transparent wall, a translucent wall, an exterior wall, a windowed wall or a wall with a doorway. It is to be appreciated that these types of walls are not particularly limited and may be defined such that the types of walls are mutually exclusive. Furthermore, it may be appreciated by a person of skill with the benefit of this description that the wall data 410a may include a floor plan as detected by the apparatus. In some examples, the wall data 410a may include wall data 410a from other apparatus 50a received via the communications interface 85a. Accordingly, the wall data 410a append additional data to generate a floor plan that extends beyond the field of view of the low resolution sensor 65a.

The database storing the grouping data 420a is to store data relating to the group with which the apparatus 50a is associated. It is to be appreciated that each apparatus 50a may be associated with more than one group. Accordingly, if the apparatus 50a is connected to a lighting device, a plurality of lighting devices may be associated with each other to be controlled in unison. For example, all lighting devices in a room may be associated with each other and recorded in the database of the grouping data 420a as a list of device identifiers.

The processor 80a further operates a grouping engine 77a. The grouping engine 77a is not particularly limited and may be operated by a separate processor or even a separate machine in other examples. The grouping engine 77a is to associate the apparatus 50a with a plurality of lighting devices in an autonomous manner. In the present example, the apparatus 50a may be added to a lighting device or integrally built into a lighting device. Accordingly, the grouping engine is to generate a grouping of the lighting devices in a commercial application. By associating the apparatus 50a with a plurality of lighting devices, the lighting device to which the apparatus 50a is connected may be controlled in unison with the plurality of lighting devices with a single lighting controller. In a specific example, the apparatus 50a may be used to determine that a lighting device is in the same room as the plurality of lighting devices and thus associate all lighting devices in room to be controlled with the lighting controller, such as a switch.

The manner by which the grouping engine 77a operates is not particularly limited. In some examples, a choice of grouping configuration may be verified or detected using supplementary data, such as a directional motion detection by the low resolution sensor 65a, or an ambient light measurement as a function of time by the low resolution sensor 65a. In some examples, the grouping engine 77a may be used to capture an intention of a designer or architect to improve the design and operation of lighting devices by analysing the lighting arrangement in combination with the supplementary data. The supplementary data is not limited and may include temporal and spatial data. In some examples, the supplementary data may include daylight intensity and motion patterns. The supplementary data may be analysed by the grouping engine 77a over a variable period of time that is sufficient in duration to achieve a desired accuracy. The motion pattern is not limited and may include directionality, velocity, frequency of movement and repetition of a given movement pattern. The ambient light pattern measurement is also not limited and may include recording the intensity, rate of change, and repetition of a given daylight reading. The manner in which these features is combined is not limited and the relative importance of each feature may be tunable by the grouping engine.

In other examples, the grouping engine 77a may determine a grouping based on a floor plan the logical number of groups based on the location of each lighting device, such as the x and y coordinates assigned on a floor plan. The lighting devices may be grouped in rows or columns or as alternating rows and/or columns.

The communications interface 85a is to communicate with an external device. In the present example, the communications interface 85a may communicate with external devices over a network, which may be a public network shared with a large number of connected devices, such as a WiFi network or cellular network. In other examples, the communications interface 85a may be to communicate over a private network. In particular, the communications interface 85a may communicate with an external device to coordinate the emission of light from the light source 55a to reduce potential interference with the external device, such as similar light from a light source of the external device. The communications may check whether the external device is in the process of emitting light to make a measurement prior to emitting light from the light source 55a.

Furthermore, the communications interface 85a may receive an external data from an external device, such as wall data or grouping data. Similarly, the communications interface 85a may transmit the wall data 410a and grouping data 420a to an external device for verification or to append their databases. The manner by which the communications interface 85a transmits and receives the data is not limited and may include receiving an electrical signal via a wired connection with other external devices or via a central server. Since the apparatus 50a is may be mounted at a stationary location, using a wired connection between the apparatus 50a and the external device may provide a robust connection. In further examples, the communications interface 85a may be a wireless interface to transmit and receive wireless signals such as via a WiFi network or directly to the external device. As another example, the communications interface 85a may connect to another proximate device via a Bluetooth connection, radio signals or infrared signals and subsequently relayed to additional devices. Although a wireless connection may be more susceptible to interference, the installation process of the apparatus 50a and associated external devices is simplified for wireless applications compared with applications that involve running a wire between devices.

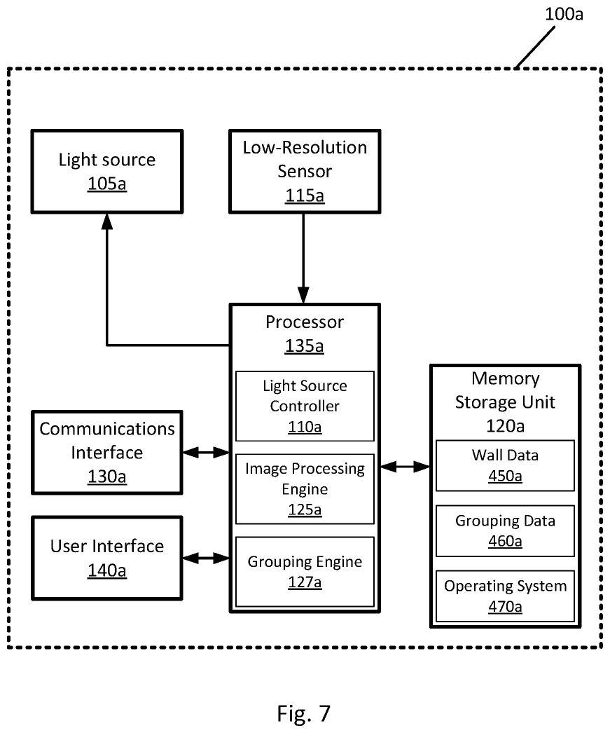

Referring to FIG. 7, another schematic representation of a lighting controller to identify and control a plurality of lighting devices is generally shown at 100a. Like components of the lighting controller 100a bear like reference to their counterparts in the lighting controller 100, except followed by the suffix “a”. In the present example, the lighting controller 100a is to collect data based on actively generated signals to locate a room boundary and to group a plurality of lighting devices. Furthermore, the lighting controller 100a is to communicate the groupings to external devices. In the present example, the apparatus 50a includes a light source 105a, a low resolution sensor 115a, a memory storage unit 120a, a communications interface 130a, a processor 135a, and a user interface 140a. In the present example, the processor 135a includes components to operate a light source controller 110a, an image processing engine 125a, and a grouping engine 127a.

In the present example, the light source 105a and the low resolution sensor 115a are substantially similar to the light source 105 and the low resolution sensor 115, respectively. In particular, the light source 105a is to emit light that is not visible to the human for use in locating and classifying room boundaries. The low resolution sensor 115a is to measure light data based on the reflected non-visible light as it is varied in intensity. Accordingly, the light source 105a and the low resolution sensor 115a may operate without changing the room lighting levels that may be visible to a human eye.

The processor 135a may include a central processing unit (CPU), a microcontroller, a microprocessor, a processing core, a field-programmable gate array (FPGA), an application-specific integrated circuit (ASIC), or similar. The processor 135a may cooperate with the memory storage unit 120a to execute various instructions stored thereon and be substantially similar to the processor 80a in the apparatus 50a.

In the present example, the memory storage unit 120a may maintain databases to store various data used by the lighting controller 100a. For example, the memory storage unit 120a may include wall data 450a and grouping data 460a. The memory storage unit 70a may additionally store an operating system 470a and additional instructions to carry out operations at the driver level as well as other hardware drivers to communicate with other components and peripheral devices of the lighting controller 100a, such as various user interfaces to receive input or provide output.

The processor 135a further operates a grouping engine 127a. The grouping engine 127a is not particularly limited and may be operated by a separate processor or even a separate machine in other examples. The grouping engine 127a is to divide the plurality of lighting devices to which the lighting controller 100a transmits control signals into subsets of lighting devices where each subset may be controlled using separate control signals. Accordingly, the lighting devices may be controlled by the lighting controller 100a as groups. In some examples, the lighting devices may each include an apparatus 50a with a grouping engine 77a that may operate in a decentralized manner to self-group. The results of the self-grouping procedure may be received by the lighting controller 100a and subsequently used to divide the lighting devices. In other examples, the lighting controller 100a may impose another grouping scheme to override the grouping data generated by the apparatus 50a.

The lighting controller 100a may also include a user interface 140a to receive input from a user. For example, the lighting controller 100a may be a wall mounted switch for controlling lighting devices in a room. In some examples, the user interface 140a may include a mechanical switch for controlling all the lighting devices in a room. The user interface 140a may also include additional switches for controlling subsets of lighting devices in the room, such as lighting devices in one end of the room.

In other examples, the user interface 140a may include a touchscreen device having soft switches or virtual switches. Accordingly, the user interface 140a may include a graphical user interface. The graphical user interface is not particularly limited and may be dynamically updated based on the groups of lighting devices generated by the grouping engine 127a or based on data received from an apparatus 50a. In some examples, the grouping of lighting devices may be continually monitored and updated to automatically adjust if the floor plan change, such as if a room boundary is a movable wall or if the walls are changed due to a renovation.

In further examples, each apparatus 50a in a system may provide additional data to the grouping engine 127a to update the grouping configuration. For example, an apparatus 50a may analyze a motion pattern detected by the low resolution sensor 65a and share the data with other apparatus 50a or the lighting controller 100a to update groups via the grouping engine 77a or the grouping engine 127a. For example, lighting devices have apparatus 50a that detect a similar motion frequency may be grouped together compared to lighting devices with apparatus 50a that detect dissimilar motion frequency. The similar motion may be used to infer that the lighting devices are in the same room or area of the room whereas dissimilar motion frequency may suggest a room boundary, such as a wall between the lighting devices. Similarly, the intensity of ambient light measurements may be used by the grouping engine 127a to divide the lighting devices.

It should be recognized that features and aspects of the various examples provided above may be combined into further examples that also fall within the scope of the present disclosure.

1. An apparatus comprising:
a light source to emit light;
a light source controller to control the light source, wherein the light source controller is to change an intensity of the light emitted by the light source;
a low resolution sensor to measure light data from a reflection of the light off a wall;
a memory storage unit to store the light data and corresponding control data; and
an image processing engine to locate and to classify the wall based on the light data and the control data.

2. The apparatus of claim 1, wherein the image processing engine is to use machine learning to classify the wall based on the light data and the control data.

3. The apparatus of claim 2, wherein the light data measured by the low resolution sensor includes an intensity distribution dependent on the intensity of the light emitted by the light source, wherein the intensity distribution is associated with a type of wall.

4. The apparatus of claim 3, wherein the machine learning is to assign a confidence value to the type of the wall.

5. The apparatus of claim 4, wherein the type of the wall is one of opaque, translucent, transparent, exterior, or doorway.

6. The apparatus of claim 1, further comprising a communications interface, wherein the light source controller is to communicate with an external device via the communications interface to coordinate the light source to reduce interference with the external device.

7. The apparatus of claim 6, further comprising a grouping engine to associate the apparatus with a plurality of lighting devices autonomously.

8. The apparatus of claim 7, wherein the plurality of lighting devices is to be controlled by a lighting controller.

9. The apparatus of claim 6, further comprising a motion sensor, wherein the motion sensor is to detect a motion, wherein the motion to be communicated to the external device to confirm a location of the wall.

10. The apparatus of claim 6, further comprising a daylight sensor, wherein the daylight sensor is to measure ambient light, wherein the ambient light is to be communicated to the external device to confirm a location of the wall.

11-12. (canceled)

13. A lighting controller comprising:
a light source to emit light;
a light source controller to control the light source, wherein the light source controller is to change an intensity of the light emitted by the light source;
a low resolution sensor to measure light data from a reflection the light off a wall;
a memory storage unit to store the light data and corresponding control data; and
an image processing engine to locate and to classify the wall based on the light data and the control data; and
a communications interface to transmit a control signal to a plurality of lighting devices, wherein each lighting device is to be bounded by the wall.

14. The lighting controller of claim 13, wherein communications interface is to receive an identifier from each lighting device of the plurality of lighting devices.

15. The lighting controller of claim 14, wherein the identifier is used to group the plurality of lighting devices.

16. The lighting controller of claim 15, further comprising a grouping engine to divide the plurality of lighting devices into a subset of lighting devices.

17. The lighting controller of claim 16, wherein the control signal is to control the subset of lighting devices.

18. The lighting controller of claim 17, wherein the grouping engine is to divide the plurality of lighting devices into a subset of lighting devices automatically based on the identifier.

19. The lighting controller of claim 13, further comprising a graphical user interface to receive input from a user, wherein the input is to generate the control signal.

20-27. (canceled)

28. A method comprising:
emitting light from a light source onto a wall;
controlling the light source to change an intensity of the light emitted by the light source;
measuring light data from a reflection of the light off a wall with a low resolution sensor;
storing the light data and corresponding control data;
locating the wall based on the light data; and
classifying the wall based on the light data and the control data using an image processing engine.

29. The method of claim 28, wherein classifying the control data applies machine learning to classify the wall into a type.

30. The method of claim 29, wherein further comprising assigning a confidence value to the type selected.

31-37. (canceled)
